(19) United States
(12) Patent Application Publication
(10) Pub. No.: US 2026/0119221 A1
(43) Pub. Date: Apr. 30, 2026

(54) SYSTEMS AND METHODS FOR COMPUTER CONTROL OF ACCESS TO RESOURCES

(71) Applicant: SHOPIFY INC., Ottawa (CA)

(72) Inventors: Tobias Lütke, Toronto (CA); Kirill Shatrov, Vancouver (CA); Jeremiah Brazeau, Andover, MA (US); Emilie Noel, Rockland (CA)

(21) Appl. No.: 18/926,452

(22) Filed: Oct. 25, 2024

(51) Int. Cl. G06F 9/455

(52) U.S. Cl. CPC G06F 9/45558

(57) ABSTRACT

A computer system may be designed to control access to resources. A ledger may be used to reflect how many units of each resource are available. There may be contention for access to the ledger. To address the technical problem of contention and to ensure more units cannot be claimed than exist, in one example, a number of rows, each corresponding to one or more units of a resource, may be created in a first intermediary database table. For each request the first database table may be queried for one or more units of a resource. The corresponding subset of rows may be returned, and row locks may be taken on each of the subset of rows, reserving the corresponding one or more units of the resource and ensuring they do not form part of the result sets for other queries that are received while the first query is in-flight.

### FIELD

The present application relates to a computer system controlling access to resources.

### BACKGROUND

A computer system may be designed to control access to resources, where for each resource a certain number of units are available. Devices may make requests to claim units of specific resources. A ledger, which could be a database table, may be used as the source of truth, reflecting how many units of each resource are available. For each resource the ledger may have a row. Each row may have a column indicating the quantity of available units of that resource. Once a unit is claimed, the ledger may be updated to reflect that the unit is no longer available.

### SUMMARY

In a computing system designed to control access to resources, a ledger, which could be a database table, may have thousands or millions of rows. The ledger may be a source of truth reflecting how many units of each resource are available. The computer system may receive concurrent, or near concurrent, requests to claim one or more units of the same resource. For example, a ledger may indicate that there are three units of a particular resource available. One device may request two of these units. Concurrently, or near concurrently, a second device may request three units of the same resource. If the second request processes while the first is in flight, both devices would receive an indication that their claim was successful. Five units would have been claimed while only three were available to be claimed. The ledger would no longer be a reliable source of truth. In some systems there may be thousands of requests per minute, leading to significant contention for access to read and modify the database ledger. This may lead to significant numbers of claims that can be made but not fulfilled.

To ensure that no claims are made that cannot be fulfilled, a reservation request system may be implemented. Instead of requests to claim units, the system may receive requests to reserve them. Once the reservation is made the system may determine if the claim can succeed. If the claim can succeed the ledger may be modified to reflect that the claimed units are no longer available. If the claim cannot succeed the reservation may be released and the units may be made available to be reserved again. The reservation request system could be implemented using the ledger by adding a column to each row indicating how many units of that resource are reserved. When a reservation request is received both this column and the column indicating the quantity of available units could be updated to indicate the number of new reserved units and to indicate that those units are no longer available. However, directly querying and updating the ledger for each reservation request may also lead to significant contention as concurrent processes compete to modify a single row. Where there are many concurrent, or near concurrent, requests for units of a particular resource, some of the requests may be held until there is an available connection to the ledger. When the ledger is a database table or forms part of a database, there may be a finite number of database connections. If there are many requests to update a particular resource in the ledger, the database system may hold requests in a queue until a database connection is made available. This may lead to exhaustion of computing resources and decreased performance across the database system which may lead to a system crash. As the queue of requests waiting on a database connection grows, requests may also time out before they are processed. Moreover, the system may receive concurrent, or near concurrent, requests to reserve units of a particular resource where the sum of the requested units is greater than the number of units of the particular resource available. It may therefore be possible for more units to be reserved than are available, as in some scenarios it may be possible for requests for units of the particular resource to process while other concurrent, or near concurrent, requests for the same resource are in-flight. The ledger may no longer be a reliable source of truth.

To address the technical problem of contention when accessing the database and try to ensure more units of a resource cannot be claimed or reserved than exist, in one example intermediary database tables may be utilized. In one example implementation, a finite number of rows, each corresponding to one unit of an available resource, may be created in a first intermediary database table. The source of this data may be a ledger. For each reservation request, the first database table may be queried for one or more units of a particular resource. If enough rows corresponding to the requested units are available, this subset of rows may be returned by the query and row locks may be taken on each of the subset of rows, reserving the corresponding one or more units of the particular resource. When a row is locked it is skipped by other queries, ensuring that it does not form part of the result sets for other queries that are received while the first query is in-flight. Information based on the subset of rows returned by the query may then be inserted into a second intermediary database table. The subset of rows may then be modified in the first database table to indicate that they are not available for reservation. For example, the modifying may comprise deleting the subset of rows from the first database table. In one example implementation, the ledger is only updated once a unit has been successfully claimed.

Technical benefits of some implementations are as follows. Intermediary database tables may be utilized to address the problem of contention, e.g. the first database table and the second database table described herein. In one implementation, each row in the first database table corresponds to only one unit of an available resource. By creating one row per unit in the first database table, each individual unit can be individually locked. This is not possible in a system that directly queries the ledger. As the ledger typically only contains one row per resource (with all available units of that resource indicated in the same single row), it is not possible to indicate that one or more of those units are locked while the rest are not. Being able to lock each unit individually via a row lock on the first database table ensures that a reservation can only be made for a unit when there is a unit available. Contention to read and modify the ledger may thereby be reduced. Instead of each request in a plurality of requests for one or more units of a particular resource reading and updating the same single row of the ledger corresponding to the particular resource, the row locking mechanism allows each row to be locked, and therefore not included in the result set of subsequent or concurrent requests. This may distribute requests to read or modify data across more rows and therefore reduce contention. Reducing contention may lead to fewer requests timing out before they are processed.

More generally, in some implementations a row of the first database table could correspond to more than one unit of an available resource, in which case the row is returned in the query and locked only if all units in that row are being reserved.

In one aspect, there is provided a computer-implemented method. The method may include receiving a request for one or more units of a particular resource. Responsive to the request, the method may further include querying a first database table. The first database table may have a plurality of rows each of which corresponds to one or more units of an available resource. The query may yield a result set containing a subset of the rows from the first database table. The query may skip row locked rows of the first database table such that the result set may be limited to rows not locked by a row lock of another transaction. Responsive to the request, the method may further include causing a row lock to be taken on each of the subset of rows in the first database table that are in the result set. Responsive to the request, the method may include inserting information based on the subset of rows in the result set into a second database table. Responsive to the request, the method may include modifying each of the subset of rows in the first database table that are in the result set.

In some implementations, each of the plurality of rows in the first database table may correspond to only one unit of the available resource. In some implementations, the information inserted into the second database table may have associated therewith an expiry time. In some implementations, modifying each of the subset of rows in the first database table may comprise deleting each of the subset of rows from the first database table.

In some implementations, responsive to determining that the expiry time has passed, the method may further include inserting the subset of rows in the result set back into the first database table. In some implementations, responsive to determining that the expiry time has passed, the method may further include deleting the information based on the subset of rows in the result set from the second database table.

In some implementations, responsive to determining that the one or more units of the particular resource can be claimed, the method may further include deleting the information based on the subset of rows in the result set from the second database table.

In some implementations, responsive to a query of the first database table returning a corresponding result set that contains no rows or fewer rows than required for a number of units of a given resource requested in the query, the method may further include retrieving, optionally from a database, a number of available units of the given resource. In some implementations, the method may further include inserting, into the first database table, a quantity of rows commensurate with the number of available units retrieved.

In some implementations, each of the rows in the first database table may correspond to only one unit of the available resource. In some implementations the corresponding result set may contain no rows or fewer rows than the number of units of the given resource requested in the query. In some implementations, the quantity of rows inserted into the first database table may equal the number of available units where each inserted row may correspond to one unit of the given resource. In some implementations, a plurality of requests, each for one or more units of a given resource, may be received. In some implementations, the number of available units retrieved, optionally from a database, may be based on how many requests for the given resource are made in a period of time.

In some implementations, querying the first database table may include specifying, in a query, an additional parameter that may correspond to a specific attribute of the one or more units of the particular resource.

In some implementations, the method may further include creating a queue that may contain a plurality of requests. Each request may be for one or more units of the particular resource. In some implementations, the method may further include combining the plurality of requests into the request.

In some implementations, responsive to determining that a resource has not been requested for a defined amount of time, the method may further comprise deleting at least one row that may correspond to one or more units of the resource from the first database table.

In some implementations, responsive to determining that a resource is no longer available, the method may further comprise deleting at least one row that may correspond to one or more units of the resource from the first database table.

In another aspect, there is provided a computer readable medium having stored thereon computer-executable instructions that, when executed by a computer, cause the computer to perform any of the methods disclosed herein. The computer readable medium may be non-transitory.

In another aspect, a system is provided that is configured to perform the methods disclosed herein. For example, the system may include at least one processor and a memory storing processor-executable instructions that, when executed by the at least one processor, cause the system to perform any of the methods disclosed herein.

### BRIEF DESCRIPTION OF THE DRAWINGS

Embodiments will be described, by way of example only, with reference to the accompanying figures wherein:

FIG. 1 illustrates an example system for computer control of access to resources.

FIG. 2 illustrates a computer-implemented method performed by a computing system, according to some implementations.

FIG. 3 illustrates an example corresponding to steps of the method of FIG. 2.

FIG. 4 illustrates an example of a computing system releasing reserved units.

FIG. 5 illustrates an example of a computing system claiming reserved units.

FIG. 6 illustrates an example of a replenishment mechanism.

### DETAILED DESCRIPTION

For illustrative purposes, specific embodiments will now be explained in greater detail in conjunction with the figures.

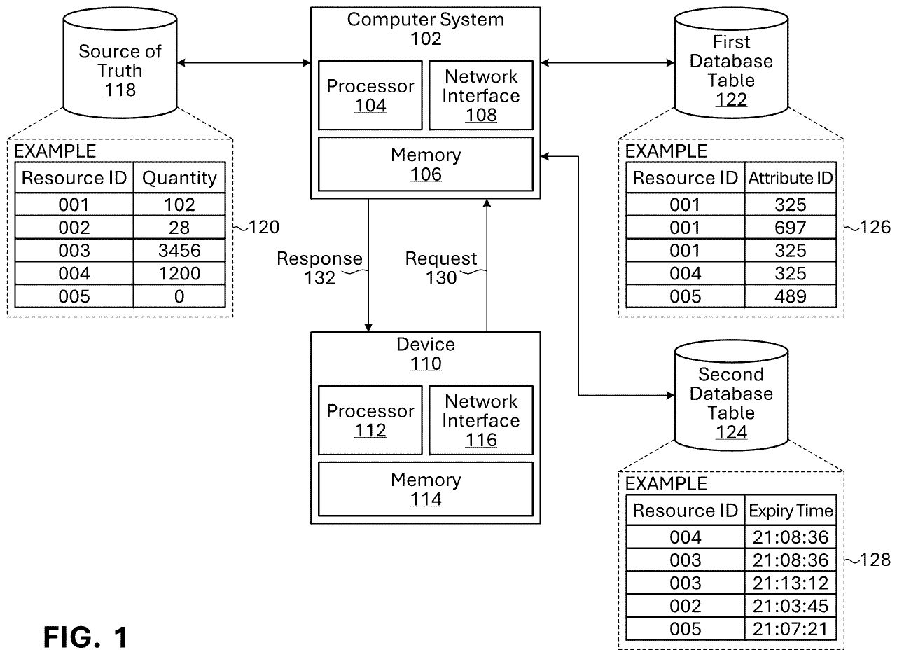

FIG. 1 illustrates an example system for computer control of access to resources. The system includes a computing system 102. The computing system 102 includes a processor 104, a memory 106, and a network interface 108. The processor 104 controls the operations of the computing system 102. The processor 104 may be implemented by one or more processors that execute instructions stored in the memory 106. Alternatively, some or all of the processor 104 may be implemented using dedicated circuitry, such as an application specific integrated circuit (ASIC), a graphics processing unit (GPU), or a programmed field programmable gate array (FPGA). The memory 106 stores information (e.g. content and/or instructions, etc.). The network interface 108 interfaces with a network (now shown) to perform communication (transmit/receive) over the network. The structure of the network interface 108 will depend on how the computer interfaces with the network. For example, if the computing system 102 is connected to the network with a network cable, the network interface 108 may comprise a network interface card (NIC), and/or a computer port (e.g. a physical outlet to which a plug or cable connects), and/or a network socket, etc.

In some implementations, the computing system 102 may be distributed, e.g. it may comprise one or more servers or computing devices, in which case processor 104 might actually consist of multiple processors communicating with each other over a communication link (e.g. over a network), and similarly memory 106 might be distributed across multiple servers or computing devices.

The system of FIG. 1 further includes a device 110. Only one device is illustrated, but the system may include multiple devices. The multiple devices may all interface with the computing system 102 in parallel. The device 110 may be a personal computer, or laptop, or desktop computer, or mobile device such as a tablet or smartphone, or an augmented reality (AR) device, or a server, etc., depending on the implementation. The device 110 includes a processor 112, memory 114, and network interface 116. The processor 112 controls the operations of the device 110. The processor 112 may be implemented by one or more processors that execute instructions stored in the memory 114. Alternatively, some or all of the processor 112 may be implemented using dedicated circuitry, such as an application specific integrated circuit (ASIC), a graphics processing unit (GPU), or a programmed field programmable gate array (FPGA). The memory 114 stores information (e.g. content and/or instructions, etc.). In some implementations, the device 110 may also include a user interface (not shown). For example, a user interface may include a display (which may be a touch screen), and/or a keyboard, and/or a mouse, etc. The network interface 108 interfaces with a network (not shown) to perform communication (transmit/receive) over the network. The structure of the network interface 116 will depend on how the device 110 interfaces with the network. For example, if the device 110 is a smartphone or tablet, the network interface 116 may comprise a transmitter/receiver with an antenna to send and receive wireless transmissions over the network. If the device 110 is a personal computer connected to the network with a network cable, the network interface 116 may comprise a network interface card (NIC), and/or a computer port (e.g. a physical outlet to which a plug or cable connects), and/or a network socket, etc.

The system of FIG. 1 may further include a database that is a source of truth 118, accessible to computing system 102. The source of truth 118 stores a record of how many units of each resource is available and is an authoritative, reliable, and trusted data source. In some implementations, the source of truth 118 may form a part of a database. For example, the source of truth 118 may be a database table. In some implementations, the source of truth 118 may be multiple and/or distributed locations from which data may be obtained, e.g. not necessarily a single storage location such as a single database.

In some implementations, the source of truth 118 may be in a ledger format as illustrated in stippled box 120. In the example source of truth shown in box 120, each row's field of the “Resource ID” column may store an identifier unique to a type of resource. In the example source of truth shown in box 120, the “Resource ID” field resolves to the scalar type “int” (Integer). In other implementations the “Resource ID” field may resolve to another scalar type. For example, in some implementations the “Resource ID” field may resolve to the scalar type “str” (String). In the example source of truth shown in box 120, each row's field of the “Quantity” column may store a number of available units of the resource. In the example source of truth shown in box 120, the “Quantity” field resolves to the scalar type “int” (Integer). In other implementations the “Quantity” field may resolve to another scalar type.

The system of FIG. 1 further includes a first database table 122 and a second database table 124, both accessible to the computing system 102. Although the two database tables are labelled “first” database table 122 and “second” database table 124, this is for ease of notation. Also, although the two database tables are separate, they might be stored on a same partition of memory, e.g. on a same server, depending upon the implementation. In some implementations the first database table 122, the second database table 124, and the source of truth 118 may form part of the same database. In some implementations, the first database table 122 and the second database table 124 may be SQL tables. In some implementations, the first database table 122 and the second database table 124 may be managed with MySQL™. In other implementations, different database systems may be used, such as, for example, PostgreSQL™, Oracle™, etc. Any database systems providing the first database table 122 includes functionality equivalent to a SELECT FOR UPDATE query with a SKIP LOCKED modifier, also known as the “FOR UPDATE SKIP LOCKED” feature of MySQL™, discussed in order to be employed in association with the subject matter of the present application. In some implementations, the first database table 122 and the second database table 124 may be non-relational, or NoSQL, database tables.

One example of the first database table 122 is illustrated in stippled box 126. In the example first database table shown in box 126, each row represents one unit of a particular resource. Each row's field of the “Resource ID” column may store an identifier of the particular resource. In the example first database table shown in box 126, the “Resource ID” field resolves to the scalar type “int” (Integer). In other implementations the “Resource ID” field may resolve to another scalar type. For example, in some implementations the “Resource ID” field may resolve to the scalar type “str” (String). In the example first database table shown in box 126, each row's field of the “Attribute ID” column may store an identifier associated with an attribute of the corresponding unit of the particular resource. For example, in some implementations the attribute may be a location where the unit is located. In the example first database table shown in box 126, the “Attribute ID” field resolves to the scalar type “int” (Integer). In other implementations the “Attribute ID” field may resolve to another scalar type. For example, in some implementations the “Attribute ID” field may resolve to the scalar type “str” (String). In some implementations the “Attribute ID” column may not be present and/or there may be additional columns corresponding to additional attributes of the unit.

In some implementations the first database table 122 is created and populated with information obtained from the source of truth 118. In some implementations a defined number of rows may be initially created in the first database table 122, representing a subset of available units of a plurality of resources where each row represents one or more units of a particular resource. In some implementations the first database table 122 may be initialized with a composite primary key. In some implementations the composite primary key may be preferred over a default primary key.

One example of the second database table 124 is shown in stippled box 128. In the example second database table shown in box 128, each row represents one unit of a particular resource. Each row's field of the “Resource ID” column may store an identifier of the particular resource. In the example second database table shown in box 128, the “Resource ID” field resolves to the scalar type “int” (Integer). In other implementations the “Resource ID” field may resolve to another scalar type. For example, in some implementations the “Resource ID” field may resolve to the scalar type “str” (String). In the example second database table shown in box 128, each row's “Expiry Time” field may resolve to the scalar type Time. In other implementations, the “Expiry Time” field may resolve to another scalar type. For example, in some implementations, the “Expiry Time” field may resolve the scalar type Datetime or the scalar type Timestamp. In some implementations the “Expiry Time” column may not be present and/or there may be additional columns storing additional information about reserved units.

In some implementations, not illustrated, the second database table 124 may be in a ledger format. The second database table 124 may be in a format similar to the example source of truth shown in box 120 where for each row representing a resource there is a field representing the reserved quantity. This may reduce the number of rows written to the second database table 124 and therefore may be beneficial for performance of operations on second database table 124.

During operation, the computing system 102 may need to execute one or more requests, e.g. requests for units of resources. A request is a request for information to be extracted from a data source, such as a database. The term “data source”, as used herein, is meant to also encompass multiple and/or distributed locations from which the data may be obtained, e.g. not necessarily a single storage location such as a single database. The first database table 122, second database table 124, and source of truth 118 are examples of data sources, and these data sources may be at single locations or distributed locations.

FIG. 1 illustrates an example in which a request 130 is transmitted by the device 110 to the computing system 102. In some implementations, the computing system 102 retrieves the data requested in request 130 from the first database table 122. The network interface 108 may be used to receive request 130 and return a response 132.

In a system designed to control access to resources, such as that shown in FIG. 1, where for each resource a certain number of units are available, there may be a large number of concurrent, or near concurrent requests, to claim resources. If the system were to only store the number of units available in a ledger format, like the example source of truth shown in box 120, and not utilize the first and second database tables 122 and 124 in the manner explained below, there may be significant contention to read and modify fields in the source of truth 118 representing quantities of available units. Some requests may be held until there is an available connection to the source of truth 118. This may lead to requests timing out before they are processed, as well as to exhaustion of computing resources This contention may also lead to the source of truth 118 no longer being reliable, as requests for units may read a quantity field before other requests for units of the same resource complete their update of the same quantity field. That is, requests for units may read the quantity field while the other requests for units of the same resource are “in-flight”. This may lead to more units of a resource being claimed than were available.

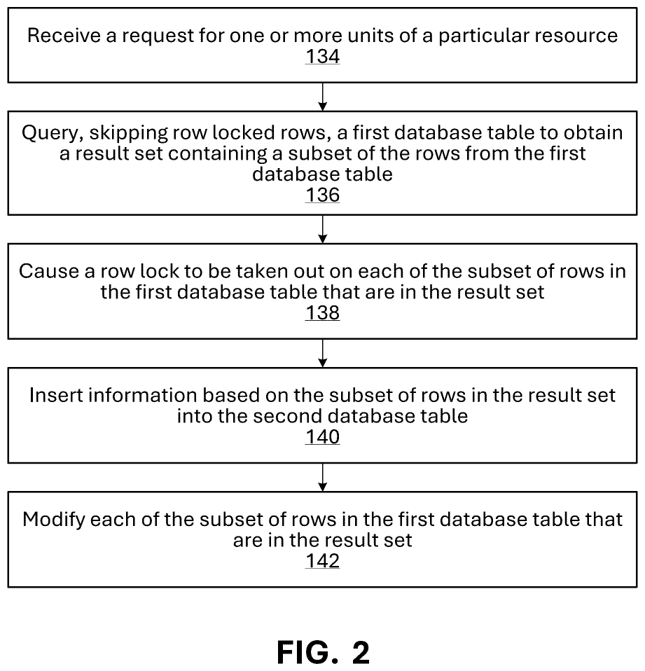

To address the technical problem of contention and try to ensure more units of a resource cannot be claimed or reserved than exist, a system could be implemented such that there is an indication to the system which units are subject to “in-flight” requests. These units may then be excluded from the units available to concurrent, or near concurrent, requests for units of the same resource. An example of such a system is that disclosed in relation to FIG. 1 performing the method of FIG. 2 described below, where the first and second intermediary database tables 122 and 124 are utilized with the row locking described herein. This is improved as compared to the previous technology, where requests for units of a particular resource directly read and modified an available quantity field of a database ledger, like the fields of the “Quantity” column in the example source of truth shown in box 120. In this previous technology, it is not possible to indicate which units are subject to “in-flight” requests. In the solution prior, each row in a ledger, like in the example source of truth shown in box 120, represents all units of a particular resource, and therefore it cannot be locked to indicate that requests for units of that resource are “in-flight”. Even if a row in the ledger could be locked, that would indicate that all units of the corresponding resource were unavailable, even if reservation requests had only been made for a fraction of them. By introducing the first database table 122, where, in some examples, each row corresponds to one unit of a resource, a row lock becomes meaningful as it locks only the unit corresponding to the locked row. In some implementations, the ability to lock each unit individually allows for transaction atomicity which helps ensure that a reservation can only be made for a unit when there is a unit available. In some implementations, this technical benefit is enabled by at least the following: the use of a database that uses locking, being able to lock an individual row in a database table, and preventing row locks from escalating to table locks, e.g. either using a database engine where there is no lock escalation or preventing lock escalation by another method. More generally, in some implementations a row of the first database table 122 could correspond to more than one unit of an available resource, allowing units to be locked in smaller sets.

FIG. 2 illustrates a computer-implemented method performed by computing system 102, according to some implementations.

At step 134, the computing system 102 receives a request 130 for one or more units of a particular resource. The request 130 may be from device 110. In some implementations, the computing system 102 receives a plurality of requests. In some implementations, the plurality of requests are from a plurality of devices.

At step 136, responsive to the request 130, the computing system 102 queries the first database table 122. The first database table 122 may have a plurality of rows each of which may correspond to one or more units of an available resource. In some implementations, each row of the plurality of rows may correspond to exactly one unit of the available resource, like in the example first database table show in box 126. The query of step 136 may yield a result set containing a subset of the rows for the first database table 122. The cardinality of the result set may match the requested number of rows. The result set may or may not be a proper subset of the rows in the first database table 122, i.e. “subset” as used herein encompasses both a proper subset and a subset that is not proper (e.g. a subset containing all rows in the set). The query of step 136 skips row locked rows of the first database table 122 such that the result set is limited to rows not locked by a row lock of another transaction.

In some implementations, the query of step 136 may be a Structured Query Language (SQL) query. In some implementations, where an appropriate database system like MySQL™ or PostgreSQL™ is implemented, the modifier “SKIP LOCKED” may be used to ensure row locked rows of the first database table 122 are excluded from the result set. In other implementations, the query of step 136 may skip locked rows using other methods or database systems. For example, in some implementations, where an appropriate database system like SQL Server™ or Sybase™ is implemented, the modifier READPAST may be used to exclude locked rows of the first database table 122 from the result set. In some implementations, where an appropriate database system like DB2™ is implemented, the modifier SKIP LOCKED DATA may be used to exclude locked rows of the first database table 122 from the result set.

In some implementations, the query of step 136 may comprise at least an identifier corresponding to a requested resource and a requested quantity of units of the requested resource. In some implementations, the query of step 136 may further comprise one or more additional parameters (e.g. an identifier), each of which corresponds to a specific attribute of the one or more units of the requested resource. The one or more additional parameters may be used to further restrict the units available for reservation. In one example implementation, an additional parameter may be a location identifier corresponding to where a particular unit of the requested resource is physically located. In this example, the location identifier may be used to restrict the result set to units of the requested resource that are located in a specific geographic area, such as near the device.

At step 138, the computing system 102 causes a row lock to be taken out in the first database table 122 on each row of the subset of rows that are in the result set. When a row is locked it means that access to the row is restricted and the row cannot be read or modified by other transactions until the lock is released. In some implementations, the locking of a row may occur upon that row being added to the result set. In some implementations, the locking of a row in the result set may happen as a side effect of the query of step 136. When the row is queried to add the row to the result set, the row is also locked, thereby preventing another concurrent or near concurrent query of another transaction from adding the row to its result set.

In some implementations, the SQL command “SELECT FOR UPDATE” may be used in the query of step 136 to cause the one or more row locks to be taken out. In one example, the query of step 136 is a SQL SELECT FOR UPDATE query with a SKIP LOCKED modifier, where “SELECT FOR UPDATE” causes any row added to the result set to be row locked in the first database table 122 and “SKIP LOCKED” causes the query 136 to skip including any row already locked in the result set.

At step 140, the computing system 102 inserts information based on the subset of rows in the result set into the second database table 124. In some implementations, a number of rows equal to the number of rows in the result set is inserted into the second database table 124. In some implementations, the second database table 124 may be in a ledger format and inserting information based on the subset of rows in the result set may comprise updating a field indicating the quantity of units of the requested resource that are reserved. In some implementations, the information inserted into the second database table 124 may include an expiry time, like in the example shown in box 128 of FIG. 2.

At step 142, the computer system 102 modifies each of the subset of rows in the first database table 122 that are in the result set. That is, the computer system 102 modifies each of the rows in the first database table 122 that were locked in step 138. In some implementations, modifying each of the subset of rows may comprise deleting each of the subset of rows from the first database table 122. The term “deleting”, as used herein, means more than just literally removing the row, e.g. a row is deleted if it is no longer considered data part of the table. For example, deleting may be accomplished via a nulling operation or the like. In other implementations, the rows may be modified in a different way, e.g. a field of each row may be modified, where the field stores a flag that indicates whether or not the one or more units represented by the row are reserved. In this implementation, the query of step 136 may skip rows that are flagged as reserved.

In some implementations of the method of FIG. 2, the first database table 122 and the second database table 124 may have relaxed durability settings. This may lead to a benefit where the source of truth 118 remains durable while the first database table 122 and the second database table 124 are persisted less often. This mix of durability may allow for increased performance when performing write operations on the first database table 122 and the second database table 124 while helping ensure that the source of truth 118 remains authoritative and reliable. In some implementations, the first database table 122 and the second database table 124 may have isolation level READ COMMITTED.

In some implementations of the method of FIG. 2, where the first database table 122 is initialized using a composite primary key, fewer row locks may be taken out per row at step 138 than if the first database table 122 had been initialized using an auto-incremented identifier as a primary key.

In some implementations of the method of FIG. 2, to ensure that a row lock does not escalate to a table lock, lock escalation may be prevented. In some implementations, the first database table 122 may be defined by a database engine where there is no lock escalation, such as InnoDB. In another implementation, lock escalation may be prevented by stopping the lock escalation mechanism of a database engine from occurring.

A “database engine”, as used herein, is meant to describe an underlying software component responsible for storing, processing, and securing data within a database. In some implementations, not illustrated, the first database table 122 may be associated with a database management system wherein the database management system comprises at least the database engine, as well as a processor and an application processing interface (API) to implement the database engine.

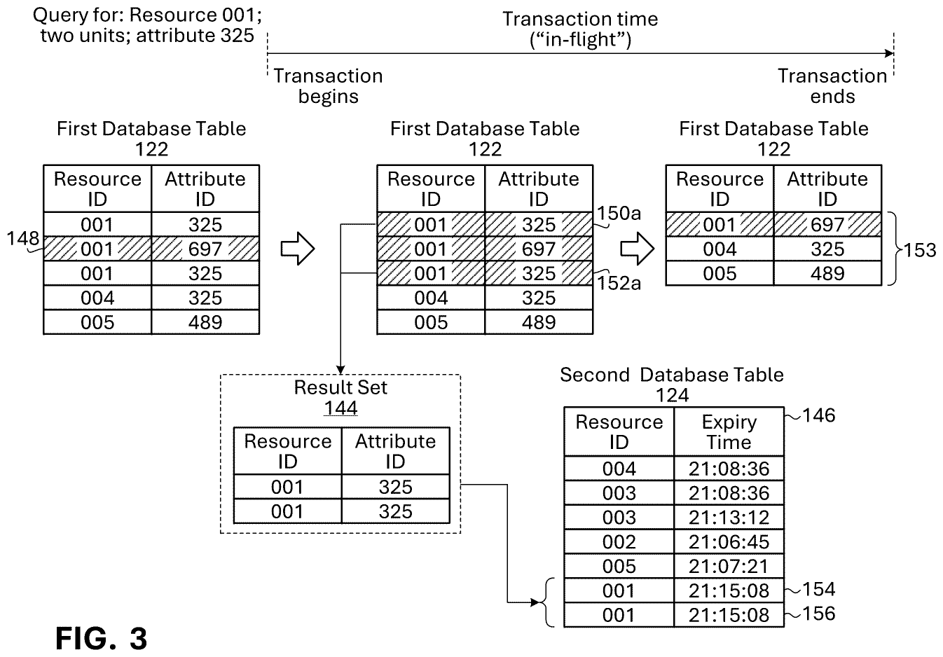

In some implementations, steps 136 to 142 may be completed in one transaction, as illustrated in FIG. 3. Performing these steps in one transaction, that is as a sequence of steps where if one step fails all steps are rolled back, allows for atomicity, ensuring that either all steps occur or none do. This may prevent partial, inaccurate updates of the first database table 122 and the second database table 124. This transaction does not happen instantaneously, and the time that it takes to complete is referred to herein as the “in-flight” time.

In some implementations, the first database table 122, the second database table 124, and the source of truth 118 may form part of the same database. This may allow transaction semantics to be enforced consistently across the first database table 122, the second database table 124, and the source of truth 118. Consistent transaction semantics may help ensure that more units of a resource cannot be claimed or reserved than exist by preventing partial, inaccurate updates of these data sources.

An example of steps 136 to 142 is illustrated in FIG. 3. The hatching is used to illustrate a row lock, such as in locked row 148. In this example, steps 136 to 142 are completed in one transaction. In this example, each row of the first database table 122 corresponds to one unit of a resource. A request to reserve two units of a resource with identifier “001” and additional attribute identifier “325” has been received by the computing system 102. Locked row 148 of the first database table 122 has already been locked by a row lock of another transaction. The computing system 102 queries the first database table 122. The query of step 136 yields example result set 144. Locked row 148 is not included in example result set 144 because it is locked and therefore skipped by the query of step 136. In this example, result set 144 consists of two rows of first database table 122 matching the requested units. The computing system 102 causes a row lock to be taken out on each of the subset of rows in the first database table 122 that are in the example result set 144. In this example these are locked rows 150a and 152a. These rows are now considered “in-flight”. Locking rows that are in-flight and excluding locked rows when querying for available units ensures that only one reservation may be made for each unit of a resource.

Information based on locked rows 150a and 152a is then inserted into the second database table 124, as illustrated by rows 154 and 156. In this example, the inserted information includes a resource identifier and an expiry time, represented by the scalar type Time. The expiry time is shown at column 146. Then, the computing system 102 modifies each of the subset of rows in the result set in the first database table 122. In this example, modifying comprises deleting each of the subset of rows in the first database table 122 such that the first database table 122 is reduced from five rows to three rows, as shown at 153. Once these steps are complete the two units of the requested resource may be considered reserved.

Note that in FIG. 3, the locking of rows 150a and 152a prevents a concurrent or near concurrent query from adding the rows 150a and 152a to its result set during the time between when the rows 150a and 152a are originally queried and locked and when the locked rows 150a and 152a are deleted. The locking acts as a temporary solution for preventing another query from adding the locked rows to its result set, until the locked rows are deleted. In some implementations, the lock of a row may automatically be released when the transaction completes, but that poses no problem because the transaction deletes the locked row.

Note that in FIG. 3 the transaction also includes inserting the information into the second database table 124, i.e. step 140 of FIG. 2. In a variation, the transaction might only encompass the actions related to the first database table 122: querying (step 136), causing the row lock (step 138, which may be part of step 136), and modifying those locked rows (step 142). Inserting the information into the second database table 124 (step 140) might be its own independent transaction.

The expiry time in the second database table 124 may represent the time at which the reserved units may be released and become available to be reserved again. For each unit of a resource, the expiry time associated with that unit is indicative of how long the reservation will be held for that unit before the unit is released (i.e. removed from the second database table 124 and added back into the first database table 122) if it is unclaimed. While the expiry time is represented with a Timestamp in the example illustrated in FIG. 3, in other implementations it may be represented by another scalar type, such as a Timestamp, Datetime, etc.

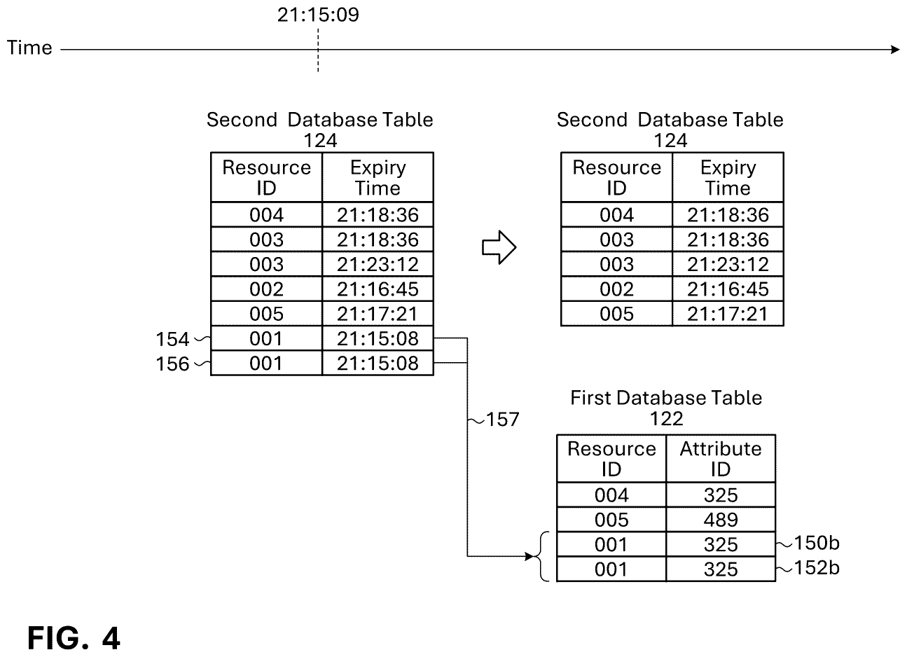

Responsive to determining that the expiry time has passed, the computer system 102 may release the reserved units. For example, some implementations of the method of FIG. 2 may include performing the following steps responsive to determining that the expiry time has passed: inserting the subset of rows in the result set back into the first database table 122, and deleting the information based on the subset of rows in the result set from the second database table 124. One example is illustrated in FIG. 4. In this example, each row of the first database table 122 corresponds to one unit of a resource. Further, in this example the time is 21:15:09 and therefore the expiry time associated with rows 154 and 156 has passed. To release the units the computer system 102 may insert the subset of rows in the result set back into the first database table 122, as shown at 157. Specifically, in the example of FIG. 4 unlocked rows 150b and 152b are inserted back into the first database table 122. The information based on the subset of rows in the result set 144 may be deleted from the second database table 124. In FIG. 4 this comprises deleting rows 154 and 156 from the second database table 124.

Inserting the subset of rows in the result set back into the first database table 122 and deleting the information based on the subset of rows in the result set from the second database table 124 may occur within one transaction. This may ensure that either both steps occur, or none do. This may prevent partial, inaccurate updates of the first database table 122 and the second database table 124.

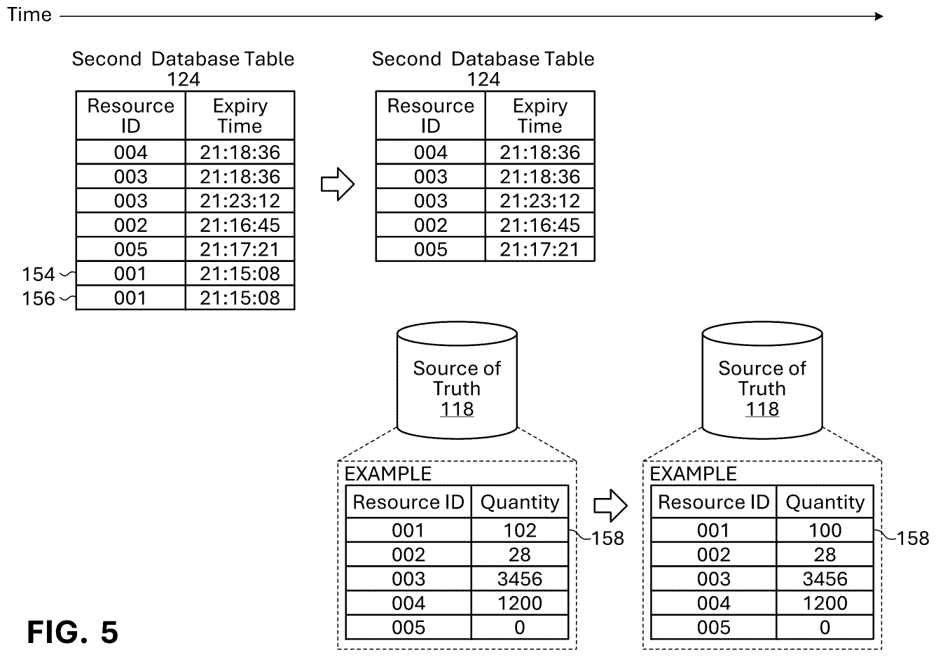

Some implementations of the method of FIG. 2 may include steps relating to claiming a unit. For example, responsive to determining that the reserved units can be claimed, the computing system 102 may claim the reserved units. The computing system 102 may delete the information based on the subset of rows in the result set from the second database table 124. In some implementations, the computing system 102 may update the source of truth 118 to indicate that the claimed units are no longer available. An example of this is shown in FIG. 5. In this example, each row of the second database table 124 corresponds to one unit of a resource. Assuming that the units represented by the information in rows 154 and 156 of the second database table 124 can be claimed, rows 154 and 156 are deleted from the second database table 124. The source of truth 118 may be updated to reflect that the units represented by rows 154 and 156 are no longer available. Specifically, in this example, field 158 is decreased by two to indicate the two units of the resource identified by “001” have been claimed.

Only updating the source of truth 118 once it is determined that a claim on one or more reserved units can succeed may help ensure that the data contained therein remains uncorrupted. It may help ensure that the source of truth 118 indicates the true number of available units to be claimed at all times. Additionally, it may minimize the number of read and modify operations on the source of truth 118. In addition to reducing contention this may reduce the load on computing resources.

In situations where there are a large number of available units, it may not be desirable to hold a similarly large number of rows in the first database table 122. For instance, in the example first database table 122 shown in box 120 of FIG. 1, there are 3456 units of resource 003 available. Assuming the first database table 122 has one row per unit of available resource, it is not desirable to have 3456 rows in first database table 122 just for resource 003. The performance of operations on the first database table 122 may be negatively impacted by a large number of rows. Additionally, writing a large number of rows to the first database table 122 may be computing resource intensive. If many of the units that these rows represent are never reserved or are removed from the available supply, adding them to the table would have been a waste of resources.

To reduce the number of rows held in the first database table 122, in some implementations a replenishment mechanism may be used. For example, if the query of step 136 yields a result set that contains no rows or fewer rows than required for the number of units of a given resource requested in the query, the computing system 102 may query the source of truth 118 for additional available units. In some implementations, the computing system 102 may query the source of truth 118 for additional available units of a particular resource when the number of units of the particular resource represented by rows of the first database table 122 falls below a threshold. For example, the replenishment mechanism may be triggered when there are fewer than 50% of the number of units originally represented in the first database table 122 remaining.

For example, in some implementations the method of FIG. 2 may include, responsive to a query of the first database table 122 returning a corresponding result set that contains no rows or fewer rows than required for a number of units of a given resource requested in the query: retrieving, from a database (which in the illustrated examples is the source of truth 118), a number of available units of the given resource, and inserting, into the first database table 122, a quantity of rows commensurate with the number of available units retrieved from the database. In some such implementations, it may be that each row of the plurality of rows in the first database table 122 corresponds to only one unit of the available resource, the corresponding result set contains no rows or fewer rows than the number of units of the given resource requested in the query, and the quantity of rows inserted into the first database table 122 equals the number of available units, each inserted row corresponding to one unit of the given resource.

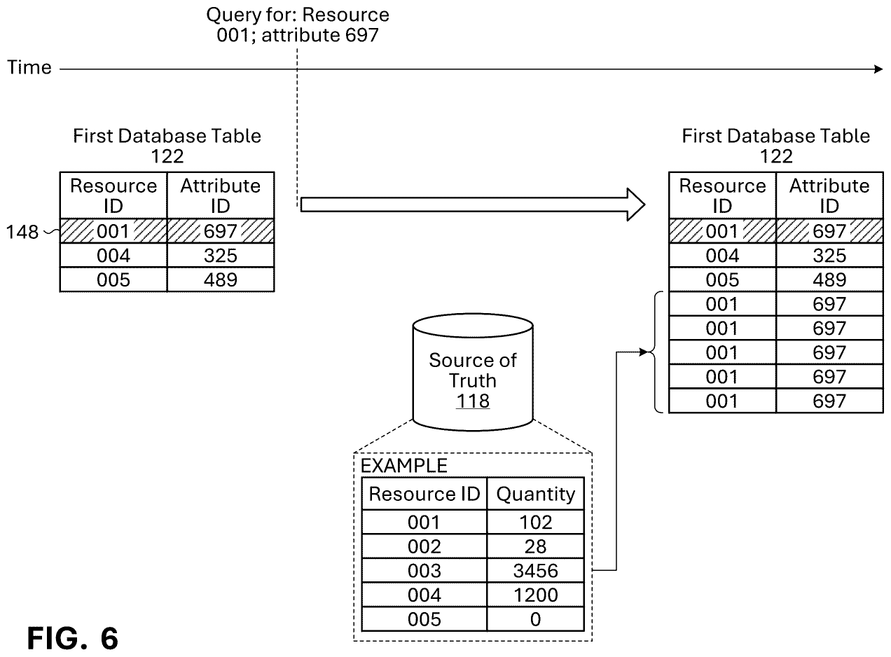

An example is illustrated in FIG. 6. In this example, each row of the first database table 122 corresponds to one unit of a resource. A request to reserve at least one unit of a resource with identifier “001” and additional attribute identifier “679” has been received by the computing system 102. As locked row 148 has a row lock, it will not be included in the result set yielded by the query of step 136 and therefore the result set will be empty. In this example, the computer system 102 then retrieves, from the source of truth 118, a number of available units with attributes that match the attributes of the requested units. In the example of FIG. 6, a defined number of units are retrieved. Specifically, five available units are retrieved. The computer system 102 then inserts, into the first database table 122, a quantity of rows equal to the number of available units retrieved from the source of truth 118. In this example, five rows are inserted into the first database table 122. In this example, the source of truth 118 is not updated at this step. In this way the source of truth 118 remains reliable as to the number of units available to be claimed. Additionally, by only reading from the source of truth 118, and not performing a write operation on it, the replenishment mechanism may be less computing resource intensive.

In some implementations, a row of the first database table 122 could correspond to more than one unit of an available resource, in which case an appropriate number of new rows may be inserted into the first database table 122 such that the number of new available units as reflected in the first database table 122 is equal to the number of available units retrieved from the source of truth 118.

In some implementations, the number of available units retrieved may be a fraction of the number of units actually available, in order to help optimize for performance of operations on the first database table 122 by avoiding creating a large number of new rows. In some implementations a defined number of new available units may be retrieved from the source of truth 118. In some implementations the number of new available units retrieved from the source of truth 118 may be adaptive, responding to the level of demand for units of a particular resource. This may help minimize replenishment operations while also helping minimize the number of rows created in the first database table 122. It may avoid overpopulating the first database table 122, which may help optimize for resource conservation and database performance due to the reduced number of rows. For example, in some implementations a plurality of requests, each for one or more units of the particular resource, may be received and the number of available units retrieved from the source of truth 118 may be based on how many requests for the particular resource are made in a period of time.

In some implementations of the replenishment mechanism, retrieving the number of available units of the given resource, and inserting, into the first database table 122, a quantity of rows commensurate with the number of available units retrieved may be completed in one transaction. This may ensure that either both steps occur, or none do. This may prevent partial or inaccurate replenishment of the first database table 122.

To help avoid duplication due to replenishment, in some implementations there may be concurrency control such that concurrent or parallel replenishment of a resource is avoided, helping avoid duplication. In some implementations the concurrency control may be in the form of a lock around the replenishment mechanism. Also, or instead, to help avoid duplication, in some implementations the number of units represented by “in-flight” rows, that is rows where the corresponding one or more units have been requested but not yet claimed, may be subtracted from the number of available units retrieved.

A large number of concurrent, or near concurrent, queries of the first database table 122 may negatively affect the performance of operations on the first database table 122. To assist in alleviating this concern, and to assist in reducing the load on computing resources, in some implementations of the method of FIG. 2 a queue, containing a plurality of requests, may be created, and the requests in the queue may be combined into a single request 130, received by the computer system 102. In some implementations of the method of FIG. 2, the computer system 102 may receive a plurality of requests. In these implementations, to assist with the performance of operations on the first database table 122 and to reduce the load on computing resources, the computer system 102 may create a queue containing the plurality of requests. The computer system 102 may then combine the requests in the queue into a single query, the query being the query of step 136. In some implementations, in order to increase efficiency, the plurality of requests combined into a single request may all be for one or more units of the same resource. In some implementations, the plurality of requests combined into a single request may all be for one or more units where at least one additional attribute of the units is the same.

In order to help minimize the number of rows in the first database table 122, and therefore to assist in database performance, rows may sometimes be removed from the first database table 122. In some implementations, the method of FIG. 2 may include the following step: responsive to determining that a resource has not been requested for a defined amount of time, rows corresponding to units of that resource may be deleted from the first database table 122. In some implementations, rows corresponding to units of a resource may be deleted from the first database table 122 responsive to determining that the corresponding resource is no longer available, e.g. if the source of truth 118 is updated to indicate that the quantity of the resource is zero.

The method of FIG. 2 and its various implementations described above may be applied in various contexts. One example is as follows. The system of FIG. 1 and method of FIG. 2 may be used to control access to resources, where those resources are timeslots, and at each timeslot there are an available quantity of processing units. The device 110 may be a client trying to reserve one or more processing units of a particular resource (i.e. of a particular time slot). The method of FIG. 2 ensures that more processing units cannot be claimed in a timeslot than are available.

Another example is as follows. The system of FIG. 1 and method of FIG. 2 may be used to control product inventory in e-commerce. In this context, a resource is a product, and the number of units of each resource available is the quantity of each product in inventory. In this example, the method of FIG. 2 and its various implementations described above may be used to support a large number of purchasers buying a limited quantity of products.

In some implementations in an e-commerce context, a reservation request 130 may be made for one or more units of a product after the purchaser submits their payment information. In some implementations, the expiry time inserted into the second database table 124 represents the time allotted for the payment information to be verified. In some implementations, if the payment information is successfully verified the computing system 102 may claim the reserved one or more units of a product. In some implementations, making a reservation request after payment information has been submitted is preferrable to making the reservation request after a unit has been added to a purchaser's online cart as, for example, the threat of bot activity is reduced.

In some implementations, in order to reduce the load on computing resources, a queue containing a plurality of requests may be created and the requests in the queue may be combined into a single request. In the e-commerce example, in some implementations, requests for units of the same product may be grouped together. In some implementations, requests include a “Shop ID”, identifying which e-commerce store the requested units are associated with, and requests including the same “Shop ID” may be grouped together. In some implementations, requests having the same product ID and Shop ID are grouped together.

In an e-commerce context it may be desirable to prevent a purchaser from reserving a unit of a product when there are no units of that product physically located near them. In this example, the query of step 136 may include an additional parameter indicating physical location which may enable the computing system 102 to only return rows of the first database table 122 corresponding to units located physically near enough to the purchaser. The Attribute ID in first database table 122 may correspond to or be indicative of physical location of the product. The query of step 136 may indicate an Attribute ID based on the physical location to which the product is to be delivered. For example, if Attribute ID “325” corresponded to location “San Francisco Warehouse”, then the query of step 136 may include Attribute ID 325 if the delivery address is in California.

In some implementations in an e-commerce context, rows may be removed from the first database table 122 when the corresponding units are no longer available, in order to help minimize the number of rows in the first database table 122, and therefore to assist in database performance. In some implementations, units may no longer be available when the corresponding product or corresponding e-commerce store has been removed from a data source (e.g. the source of truth 118).

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
receiving a request for one or more units of a particular resource; and
responsive to the request:
querying a first database table, the first database table having a plurality of rows each of which corresponds to one or more units of an available resource, the querying yielding a result set containing a subset of the rows from the first database table, wherein the querying skips row locked rows of the first database table such that the result set is limited to rows not locked by a row lock of another transaction;
causing a row lock to be taken on each of the subset of rows in the first database table that are in the result set;
inserting information based on the subset of rows in the result set into a second database table; and
modifying each of the subset of rows in the first database table that are in the result set.

2. The computer-implemented method of claim 1, wherein:
each row of the plurality of rows in the first database table corresponds to only one unit of the available resource;
the information inserted into the second database table has associated therewith an expiry time; and
modifying each of the subset of rows in the first database table comprises deleting each of the subset of rows from the first database table.

3. The computer-implemented method of claim 2 further comprising:
responsive to determining that the expiry time has passed:
inserting the subset of rows in the result set back into the first database table; and
deleting the information based on the subset of rows in the result set from the second database table.

4. The computer-implemented method of claim 1 further comprising:
responsive to determining that the one or more units of the particular resource can be claimed, deleting the information based on the subset of rows in the result set from the second database table.

5. The computer-implemented method of claim 1 further comprising:
responsive to a query of the first database table returning a corresponding result set that contains no rows or fewer rows than required for a number of units of a given resource requested in the query:
retrieving, from a database, a number of available units of the given resource;
inserting, into the first database table, a quantity of rows commensurate with the number of available units retrieved from the database.

6. The computer-implemented method of claim 5, wherein:
each row of the plurality of rows in the first database table corresponds to only one unit of the available resource;
the corresponding result set contains no rows or fewer rows than the number of units of the given resource requested in the query; and
the quantity of rows inserted into the first database table equals the number of available units, each inserted row corresponding to one unit of the given resource.

7. The computer-implemented method of claim 5 wherein a plurality of requests, each for one or more units of the given resource, are received and the number of available units retrieved from the database is based on how many requests for the given resource are made in a period of time.

8. The computer-implemented method of claim 1 wherein querying the first database table includes specifying, in a query, an additional parameter that corresponds to a specific attribute of the one or more units of the particular resource.

9. The computer-implemented method of claim 1 further comprising:
creating a queue containing a plurality of requests, each for one or more units of the particular resource; and
combining the plurality of requests into the request.

10. The computer-implemented method of claim 1 further comprising:
responsive to determining that a resource has not been requested for a defined amount of time, deleting at least one row that corresponds to one or more units of the resource from the first database table.

11. The computer-implemented method of claim 1 further comprising:
responsive to determining that a resource is no longer available, deleting at least one row that corresponds to one or more units of the resource from the first database table.

12. A non-transitory computer readable medium having stored thereon computer-executable instructions that, when executed by a computer, cause the computer to perform operations comprising:
receiving a request for one or more units of a particular resource; and
responsive to the request:
querying a first database table, the first database table having a plurality of rows each of which corresponds to one or more units of an available resource, the querying yielding a result set containing a subset of the rows from the first database table, wherein the querying skips row locked rows of the first database table such that the result set is limited to rows not locked by a row lock of another transaction;
causing a row lock to be taken on each of the subset of rows in the first database table that are in the result set;
inserting information based on the subset of rows in the result set into a second database table; and
modifying each of the subset of rows in the first database table that are in the result set.

13. The non-transitory computer readable storage medium of claim 12, wherein:
each row of the plurality of rows in the first database table corresponds to only one unit of the available resource;
the information inserted into the second database table has associated therewith an expiry time; and
modifying each of the subset of rows within the first database table comprises deleting each of the subset of rows from the first database table.

14. The non-transitory computer readable storage medium of claim 13 wherein the instructions, when executed by the computer, cause the computer to perform operations further comprising:
responsive to determining that the expiry time has passed:
inserting the subset of rows in the result set back into the first database table; and
deleting the information based on the subset of rows in the result set from the second database table.

15. The non-transitory computer readable storage medium of claim 12 wherein the instructions, when executed by the computer, cause the computer to perform operations further comprising:
responsive to determining that the one or more units of the particular resource can be claimed, deleting the information based on the subset of rows in the result set from the second database table.

16. The non-transitory computer readable storage medium of claim 12 wherein the instructions, when executed by the computer, cause the computer to perform operations further comprising:
responsive to a query of the first database table returning a corresponding result set that contains no rows or fewer rows than required for a number of units of a given resource requested in the query:
retrieving, from a database, a number of available units of the given resource;
inserting, into the first database table, a quantity of rows commensurate with the number of available units retrieved from the database.

17. The non-transitory computer readable storage medium of claim 16 wherein a plurality of requests, each for one or more units of the given resource, are received and the number of available units retrieved from the database is based on how many requests for the given resource are made in a period of time.

18. The non-transitory computer readable storage medium of claim 12 wherein querying the first database table includes specifying, in a query, an additional parameter that corresponds to a specific attribute of the one or more units of the particular resource.

19. The non-transitory computer readable storage medium of claim 12 wherein the instructions, when executed by the computer, cause the computer to perform operations further comprising:
creating a queue containing a plurality of requests, each for one or more units of the particular resource; and
combining the plurality of requests into the request.

20. A system comprising:
at least one processor; and
a memory storing processor-executable instructions that, when executed by the at least one processor, cause the system to:
receive a request for one or more units of a particular resource; and
responsive to the request:
query a first database table, the first database table having a plurality of rows each of which corresponds to one or more units of an available resource, the query yielding a result set containing a subset of the rows from the first database table, wherein the query skips row locked rows of the first database table such that the result set is limited to rows not locked by a row lock of another transaction;
cause a row lock to be taken on each of the subset of rows in the first database table that are in the result set;
insert information based on the subset of rows in the result set into a second database table; and
modify each of the subset of rows in the first database table that are in the result set.
